(19) United States
(12) Patent Application Publication
(10) Pub. No.: US 2026/0124839 A1
(43) Pub. Date: May 7, 2026

(54) LIQUID EJECTING APPARATUS AND LIQUID EJECTION HEAD

(71) Applicant: CANON KABUSHIKI KAISHA, Tokyo (JP)

(72) Inventor: YUJI TAMARU, Tokyo (JP)

(21) Appl. No.: 19/373,423

(22) Filed: Oct. 29, 2025

(30) Foreign Application Priority Data
Nov. 1, 2024 (JP) 2024-192850

(51) Int. Cl. B41J 2/175; B41J 2/18

(52) U.S. Cl. CPC B41J 2/17596; B41J 2/17523; B41J 2/18; B41J 2/17563

(57) ABSTRACT

A technique capable of circulating liquid while suppressing a pump drive voltage is provided. There is provided a liquid ejection head including: an ejection unit capable of ejecting liquid; and a circulation path configured to supply liquid to the ejection unit and to collect liquid that has not been ejected from the ejection unit, and the circulation path includes a plurality of pumps configured to pump liquid by displacing the volume of a pump chamber using a piezoelectric element or a solenoid.

### BACKGROUND

### Field of the Technology

The present disclosure relates to a liquid ejecting apparatus and a liquid ejection head.

### Description of the Related Art

Japanese Patent Laid-Open No. 2018-030350 discloses a printing apparatus provided with a drive circuit that drives a pump for circulating ink based on an output from a pressure sensor in a circulation path for circulating ink between two storage portions capable of storing ink and an inkjet head.

However, in the printing apparatus disclosed in Japanese Patent Laid-Open No. 2018-030350, a pump drive voltage is initially set at 200 V and is modulated over a range from 120 V to 300 V, and a high drive voltage must be applied to the pump for circulating ink. Thus, in the printing apparatus of Japanese Patent Laid-Open No. 2018-030350, it is necessary to add constituents and functions for suppressing the effects of high voltage, which results in an increase in the size and cost of the apparatus.

### SUMMARY

The present disclosure is made in view of the above problem and provides a technique capable of circulating liquid while suppressing a pump drive voltage.

A liquid ejecting apparatus according to some embodiments includes a liquid ejection head comprising an ejection unit capable of ejecting liquid and a circulation path configured to supply liquid to the ejection unit and to collect liquid that has not been ejected from the ejection unit, wherein the circulation path includes a plurality of pumps configured to pump liquid by displacing a volume of a pump chamber using a piezoelectric element or a solenoid.

Features of the present disclosure will become apparent from the following description of embodiments with reference to the attached drawings. The following description of embodiments is described by way of example

### BRIEF DESCRIPTION OF THE DRAWINGS

FIGS. 1A and 1B are schematic configuration diagrams of a printing mechanism.

FIG. 2 is an exploded perspective view of a print head.

FIG. 3 is a schematic configuration diagram of a circulation unit.

FIG. 4 is a schematic configuration diagram of a circulation path in a first embodiment.

FIG. 5 is a schematic configuration diagram of a drive mechanism of a circulation pump.

FIG. 6 is a schematic configuration diagram of the circulation path in a comparative example.

FIG. 7 is a diagram showing pump performance in Example 1 and the comparative example.

FIG. 8 is a schematic configuration diagram of the circulation path in a second embodiment.

FIG. 9 is a diagram showing pump performance in Example 2 and the comparative example.

FIG. 10 is a schematic configuration diagram of the circulation unit in a third embodiment.

FIG. 11 is a schematic configuration diagram of the circulation path in the third embodiment.

FIG. 12 is a schematic configuration diagram of the circulation path in a fourth embodiment.

FIG. 13 is a schematic configuration diagram of the circulation path in a fifth embodiment.

FIG. 14 is a schematic configuration diagram of the circulation unit in a sixth embodiment.

FIG. 15 is a schematic configuration diagram of the circulation path in the sixth embodiment.

### DESCRIPTION OF THE EMBODIMENTS

Hereinafter, an example of embodiments of a liquid ejecting apparatus and a liquid ejection head will be described in detail with reference to the accompanying drawings. Incidentally, the following embodiments do not limit the present disclosure, and not all of combinations of features described in the present embodiments are necessarily essential to a solution to the problem to be solved by the present disclosure. Further, the positions, shapes, and the like of constituents described in the embodiments are merely examples and are not intended to limit the present disclosure only thereto.

### First Embodiment

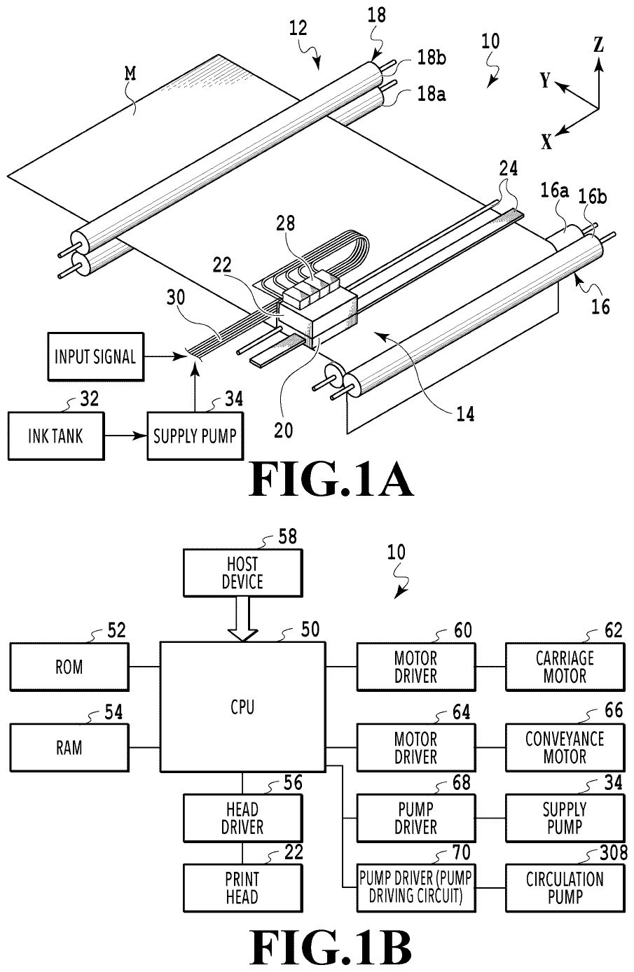

First, a liquid ejecting apparatus according to a first embodiment will be described in detail with reference to FIGS. 1A to 7. In the present embodiment, a so-called serial scan type printing apparatus in which while a print head that ejects ink as liquid is moved in the width direction of a print medium, ink is ejected from the print head onto the print medium to perform printing will be described as an example of a liquid ejecting apparatus.

### Configuration of Printing Apparatus

FIGS. 1A and 1B are schematic configuration diagrams of the printing apparatus. FIG. 1A is a perspective view and FIG. 1B is a block diagram showing a configuration of a control system.

A printing apparatus 10 according to the present embodiment includes a conveying portion 12 that conveys a print medium (hereinafter also referred to as “medium”) M and a printing portion 14 that ejects ink onto the print medium M conveyed by the conveying portion 12 to perform printing (see FIG. 1A).

The conveying portion 12 includes two conveying roller pairs 16 and 18. The conveying roller pair 16 includes a conveying roller 16a that rotates by a conveying motor 66 (see FIG. 1B) being driven and a driven roller 16b that is driven in pressure contact with the conveying roller 16a. The conveying roller pair 18 includes a conveying roller 18a that rotates by the conveying motor 66 being driven and a driven roller 18b that is driven in pressure contact with the conveying roller 18a. In the conveying portion 12, in conveying the print medium M, the conveying roller pair 16 nips the print medium M with the conveying roller 16a and the driven roller 16b, and the conveying roller pair 18 nips the print medium M with the conveying roller 18a and the driven roller 18b. The two conveying roller pairs 16 and 18 cooperate to convey the print medium M. Incidentally, a specific configuration of the conveying portion 12 is not limited to this, and various known configurations capable of conveying a print medium may be used.

The printing portion 14 includes a carriage 20 provided so as to be movable in a direction (X direction) intersecting (orthogonal to in the present embodiment) a conveyance direction (Y direction) in which the print medium M is conveyed, and a print head 22 that is mounted on the carriage 20 and ejects ink onto a print medium being conveyed. In the present embodiment, the print head 22 functions as a liquid ejection head that ejects ink as liquid.

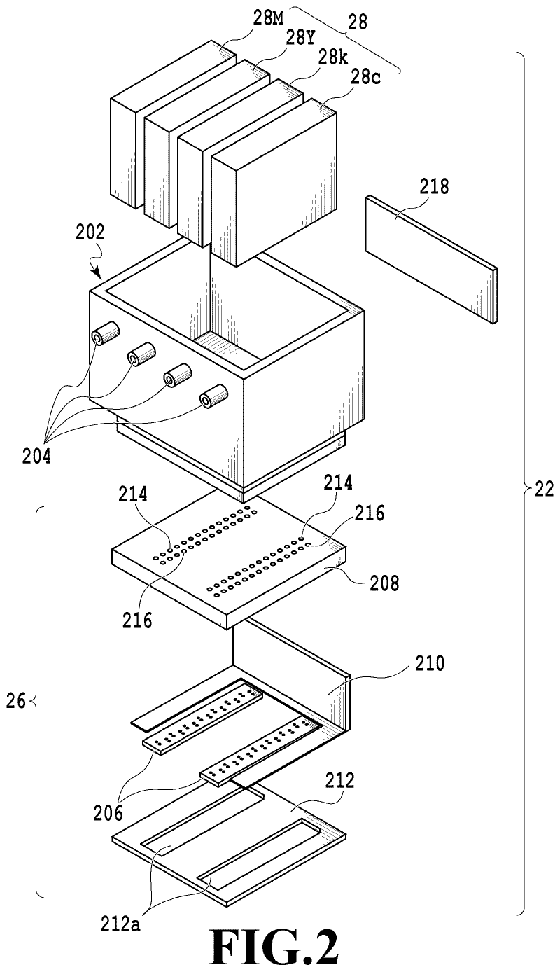

The carriage 20 is slidably provided on a guide rail 24 extending in the X direction and is configured to be able to reciprocally move in the X direction along the guide rail 24 by being driven by a carriage motor 62 (see FIG. 1B). The print head 22 includes an ejection unit 26 (see FIG. 2) for ejecting supplied ink and a circulation unit 28 for circulating the supplied ink.

The ejection unit 26 includes an ejection energy generating element and is driven by an input signal (driving signal) being input from an electrical connection substrate (not shown) provided in the printing apparatus 10 via electrical wiring provided in a guide 30. The ejection energy generating element is driven, so that ink is ejected from an ejection port provided in the ejection unit 26.

A detailed configuration of the circulation unit 28 will be described later, but the circulation unit 28 is connected to the ejection unit 26 so that liquid can be fed, that is, is fluidly connected to the ejection unit 26. Further, the circulation unit 28 is supplied with ink via a tube provided in the guide 30. The tube is connected to an ink tank 32, and ink is transferred from the ink tank 32 to the circulation unit 28 by a supply pump 34 being driven.

In the present embodiment, the print head 22 is configured to be removable from and attachable to the carriage 20 by a user. The print head 22 is also configured to eject four different types of inks, specifically, a cyan (C) ink, a magenta (M) ink, a yellow (Y) ink, and a black (K) ink, to enable full-color printing. The print head 22 is provided with a circulation unit 28 in correspondence with the type of ink. Thus, in the present embodiment, the print head 22 is provided with four circulation units 28.

In the printing apparatus 10, the types of inks that can be ejected from the print head 22 are not limited to the above four types, but may be one, two, three, or five or more types of inks. Further, liquid that can be ejected from the print head 22 is not limited to ink that contains color material but includes ink that contains no color material and various types of processing liquids for subjecting ink after ejection to a predetermined process.

The printing apparatus 10 performs a printing operation in which ink is ejected to perform printing based on print data while the print head 22 moves (scans) in the X direction on the print medium M that has been conveyed to a print start position by the conveying portion 12. Next, a conveyance operation is performed in which the conveying portion 12 conveys the print medium M by a predetermined amount and then the printing operation is performed again. In this way, the printing apparatus 10 executes printing on the print medium M based on print data by alternately and repeatedly performing the printing operation and the conveyance operation.

Although not shown, the printing apparatus 10 also includes a maintenance portion for maintaining and recovering the ink ejection characteristics of the print head 22. The maintenance portion includes, for example, a cap for protecting an ejection port surface of the print head 22 on which an ejection port for ejecting ink is formed, a wiper for wiping the ejection port surface, and a suction portion for forcibly sucking ink from the ejection port. The constituents of the maintenance portion are not limited to the above three, and various known constituents capable of maintaining and recovering the ink ejection performance of the print head 22 can be used.

The printing apparatus 10 includes a central processing unit (CPU) 50 as a control portion that controls the overall operation of the printing apparatus 10 (see FIG. 1B). The CPU 50 develops various control programs stored in a ROM 52 into a RAM 54 and controls each constituent of the printing apparatus 10. The RAM 54 is a readable and writable memory formed of, for example, a DRAM and includes an area into which a control program is to be developed as well as an area for temporarily storing various kinds of data.

The CPU 50 is connected to a head driver 56 and drives the print head 22 via the head driver 56. Specifically, the CPU 50 controls driving of an ejection energy generating element provided in the ejection unit 26. For example, the CPU 50 controls driving of a plurality of ejection energy generating elements based on image data input from a host device 58 provided separately from the printing apparatus 10.

The CPU 50 is connected to a motor driver 60 and drives a carriage motor 62 via the motor driver 60 to control movement of the carriage 20. The CPU 50 is also connected to a motor driver 64 and drives a conveying motor 66 via the motor driver 64 to control driving of the conveying roller pairs 16 and 18.

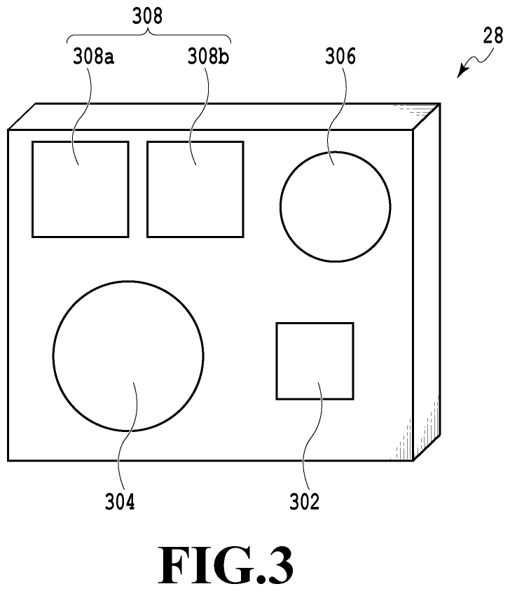

The CPU 50 includes a pump driver 68 and controls driving of the supply pump 34 via the pump driver 68 to control the supply of ink to the print head 22. The CPU 50 is also connected to a pump driver (hereinafter also referred to as “pump driving circuit”) 70 and drives a circulation pump 308 (see FIG. 3) for circulating ink between the circulation unit 28 and the ejection unit 26 via the pump driver 70 to control ink circulation in a circulation path 400 (described later).

### Configuration of Print Head

Next, a configuration of the print head 22 will be described. FIG. 2 is an exploded perspective view of the print head 22.

In the print head 22, the circulation unit 28 is connected to the ejection unit 26 via a flow path member 202. The circulation unit 28 is connected to the flow path member 202, and a method for connecting the circulation unit 28 and the flow path member 202 may be a screw fastening method with a seal member sandwiched between the circulation unit 28 and the flow path member 202 or a connection by welding, and various known connection methods can be used.

The flow path member 202 includes a joint 204 to which a tube provided in the guide 30 is connected. As described above, the print head 22 is configured to be detachable from the carriage 20, and in a case where the print head 22 is mounted on the carriage 20, the tube is connected to the joint 204. In the present embodiment, four circulation units 28 corresponding to the types of inks are provided. Specifically, a circulation unit 28C corresponding to the C ink, a circulation unit 28K corresponding to the K ink, a circulation unit 28Y corresponding to the Y ink, and a circulation unit 28M corresponding to the M ink are provided. The number of the joints 204 corresponds to the number of the circulation units 28, which is four, and in the present embodiment, the four joints 204 are provided. As a result, each circulation unit 28 connected to the flow path member 202 can be supplied with ink via the tube and the joint 204 from the ink tank 32 in which a corresponding ink is stored.

The ejection unit 26 is connected to the bottom surface of the flow path member 202. The bottom surface of the flow path member 202 is provided with a supply port (not shown) for supplying ink from the circulation unit 28 to the ejection unit 26 and a collection port (not shown) for collecting ink flowed out from the ejection unit 26. The ejection unit 26 and the flow path member 202 may be connected to each other by, for example, adhesive fixation with an adhesive or by screw fastening fixation with a sealing member sandwiched therebetween.

The ejection unit 26 includes an ejection element substrate 206 on which an ejection energy generating element is provided and a support member 208 that supports the ejection element substrate 206. The ejection unit 26 also includes an electric wiring substrate 210 for sending an electric signal to the ejection element substrate 206 and a cover member 212 that protects the electric wiring substrate 210.

The ejection element substrate 206 is provided with a plurality of ejection ports for ejecting ink, and ejection energy generating elements are provided in positions corresponding to the respective ejection ports. The support member 208 includes a flow path 214 for supplying the ejection element substrate 206 with ink supplied from the circulation unit 28 via the flow path member 202 and a flow path 216 for collecting ink that has not been ejected from the ejection ports in the ejection element substrate 206. Thus, in the ejection unit 26, ink supplied from the circulation unit 28 passes through the flow path 214, the ejection element substrate 206, and the flow path 216 and is collected into the circulation unit 28.

The ejection element substrate 206 and the electric wiring substrate 210 are adhesively fixed to the support member 208, and the cover member 212 is adhesively fixed so as to cover the electric wiring substrate 210 adhesively fixed to the support member 208. At this time, all the ejection ports provided in the ejection element substrate 206 are located inside an opening 212a formed in the cover member 212. The ejection element substrate 206 and the electric wiring substrate 210 are electrically connected by, for example, wire bonding. Incidentally, for a method for electrically connecting the ejection element substrate 206 and the electric wiring substrate 210, various known techniques such as flying lead bonding may be used.

A head substrate 218 for receiving an electric signal from a main body is connected to a surface of the flow path member 202 opposite to a surface on which the joint 204 is provided. The electric signal output from the main body is sent to the electric wiring substrate 210 of the ejection unit 26 via the head substrate 218 and is then sent from the electric wiring substrate 210 to the ejection element substrate 206. The head substrate 218 and the flow path member 202 may be connected to each other by fixation by caulking or with an adhesive, or by fixation with a double-sided tape. The head substrate 218 and the electric wiring substrate 210 are electrically connected to each other by ACF pressure bonding. The head substrate 218 and the electric wiring substrate 210 may be electrically connected to each other by, for example, wire bonding or flying lead bonding.

### Configuration of Circulation Unit

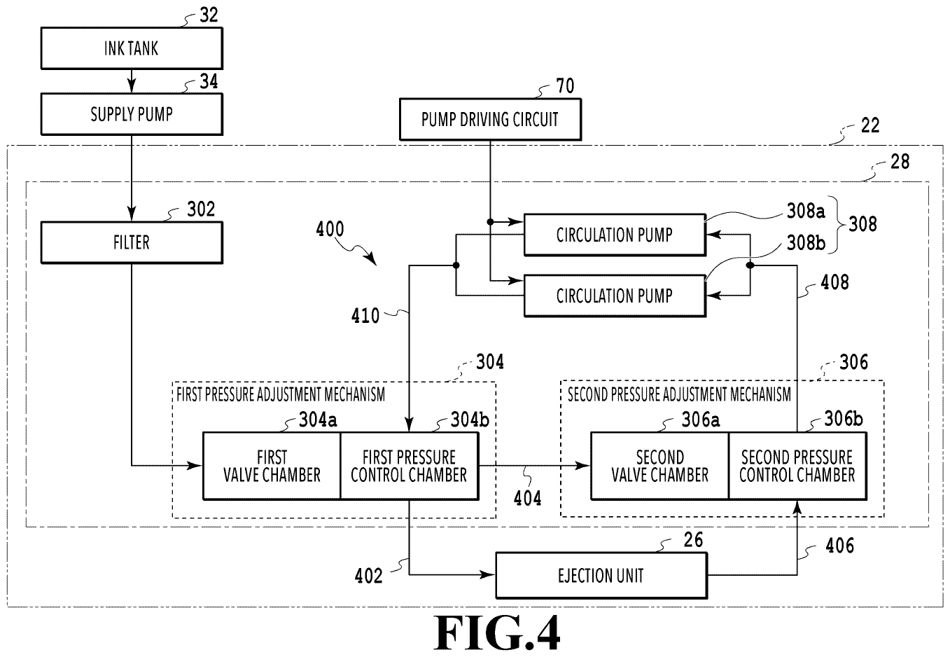

Next, an outline of a configuration of the circulation unit 28 will be described. FIG. 3 is a schematic configuration diagram of the circulation unit 28. In the present embodiment, the number of the circulation units 28 shown in FIG. 3 correspond to the number of inks used in the printing apparatus 10. The circulation unit 28 includes a filter 302, a first pressure adjustment mechanism 304, a second pressure adjustment mechanism 306, and a plurality of circulation pumps 308. In the present embodiment, the circulation unit 28 is provided with the two circulation pumps 308, that is, a circulation pump 308a and a circulation pump 308b, which cooperate to circulate ink in a circulation path. These constituents are connected via a flow path as shown in FIG. 4 and constitute the circulation path 400 (described later) that supplies and collects ink to and from the ejection unit 26 provided with the ejection element substrate 206 in the print head 22.

### Circulation Path

Next, the circulation path 400 including the circulation unit 28 and the ejection unit 26 and formed in the print head 22 will be described. FIG. 4 is a schematic configuration diagram of the circulation path 400 formed in the print head 22. Incidentally, in FIG. 4, the flow path member 202 is omitted to facilitate understanding. Further, the circulation path shown in FIG. 4 shows a circulation path for one ink. Thus, in the printing apparatus 10 configured to eject four colors of inks, the four circulation paths shown in FIG. 4 are formed.

### Configuration of Circulation Path

First, a configuration of the circulation path 400 will be described. In the circulation path 400, in the first pressure adjustment mechanism 304, a first pressure control chamber 304b is connected to the ejection unit 26 via a supply flow path 402 and is connected to a second valve chamber 306a of the second pressure adjustment mechanism 306 via a bypass flow path 404. Further, in the circulation path 400, the ejection unit 26 is connected to the second pressure control chamber 306b of the second pressure adjustment mechanism 306 via a collection flow path 406. Furthermore, in the circulation path 400, the second pressure control chamber 306b is connected to the circulation pumps 308a and 308b via a first flow path 408. Moreover, in the circulation path 400, the circulation pumps 308a and 308b are connected to the first pressure control chamber 304b via a second flow path 410. Incidentally, the circulation pump 308a and the circulation pump 308b are connected in parallel to the first flow path 408 and the second flow path 410.

Each of the circulation pumps 308a and 308b is a piezoelectric diaphragm pump in which a drive voltage is input to a piezoelectric element attached to a diaphragm to change the volume of the inside of a pump chamber (volume displacement) and move two check valves alternately due to pressure fluctuations to feed liquid. The drive voltage is supplied to the circulation pumps 308a and 308b by the pump driving circuit 70. The circulation pumps 308a and 308b are arranged in the circulation path 400 so as to feed ink from the first flow path 408 to the second flow path 410 by being driven.

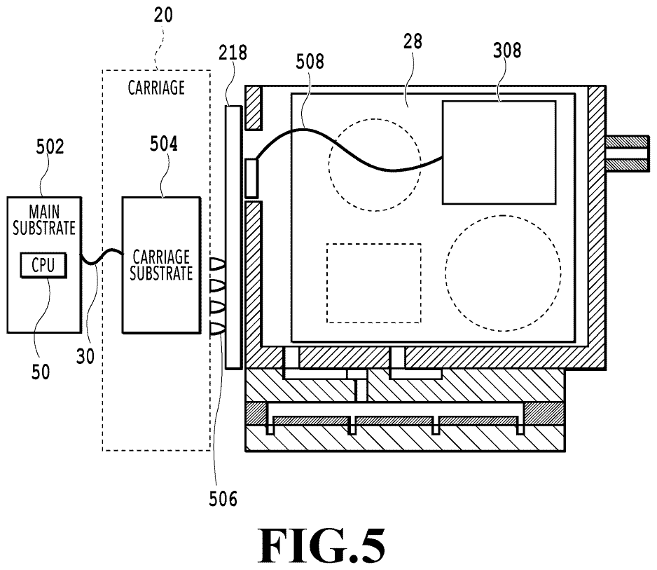

Here, the drive mechanism of the circulation pump 308 will be described. FIG. 5 is a schematic configuration diagram of the drive mechanism of the circulation pumps 308a and 308b. In FIG. 5, to facilitate understanding, the circulation pump 308 is shown as one member in the circulation unit 28.

In the printing apparatus 10, an input signal (drive signal) is sent from the CPU 50 mounted on a main substrate 502 to a carriage substrate 504 mounted on the carriage 20 via electrical wiring provided in the guide 30. Upon receipt of a drive signal, the carriage substrate 504 outputs a control signal and a reference voltage for the pump driving circuit 70 to the head substrate 218 via an electrical connection portion 506 through contact connection. Incidentally, the pump driving circuit 70 is mounted on the head substrate 218.

The pump driving circuit 70 to which the control signal and the reference voltage are input outputs a pump drive signal (drive voltage) to the circulation pump 308 via harness wiring 508, which drives the circulation pump 308 and circulates ink in the circulation path 400. That is, the same drive signal is output from the pump driving circuit 70 to the circulation pumps 308a and 308b at the same time. Incidentally, the pump driving circuit 70 may be provided in a member different from the head substrate 218, such as the carriage substrate 504 or the main substrate 502. The circulation pump 308 is preferably driven at a pump drive voltage lower than 42.4 V. For example, IEC60950-1 and IEC62368-1 stipulate preferable voltages in terms of electrical safety. The drive voltage for the circulation pump 308 is set at a value lower than 42.4 V, whereby it is possible to avoid design restrictions due to high voltages.

### Ink Circulation in Circulation Path

Next, ink circulation in the circulation path 400 will be described with reference to FIG. 4. Ink fed from the ink tank 32 by the supply pump 34 is supplied to the circulation unit 28 via the joint 204 connected to a tube. The ink supplied to the circulation unit 28 passes through the filter 302 to eliminate dust and the like and then flows into a first valve chamber 304a of the first pressure adjustment mechanism 304.

Pressure on the ink flowing into the first valve chamber 304a is adjusted in a case where the ink is transferred to the first pressure control chamber 304b in communication with the first valve chamber 304a via a valve. Incidentally, the first pressure adjustment mechanism 304 is configured to have a relatively higher control pressure than the second pressure adjustment mechanism 306. The ink flowing into the first pressure control chamber 304b is transferred to the ejection unit 26 via the supply flow path 402 by the circulation pumps 308a, 308b being driven and is also transferred to the second valve chamber 306a via the bypass flow path 404.

The ink transferred to the ejection unit 26 is transferred to the ejection element substrate 206 via a flow path 214 formed in the ejection unit 26 for supplying ink to the ejection element substrate 206. Ink that has not been ejected from the ejection element substrate 206 is transferred to a collection flow path 406 via the flow path 216 formed in the ejection unit 26 for collecting ink from the ejection element substrate 206 and is then transferred to the second pressure control chamber 306b.

Pressure on the ink transferred to the second valve chamber 306a is adjusted in a case where the ink is transferred to the second pressure control chamber 306b in communication with the second valve chamber 306a via a valve. Incidentally, the second pressure adjustment mechanism 306 is configured to have a relatively lower control pressure than the first pressure adjustment mechanism 304. The ink transferred to the second pressure control chamber 306b is transferred to the first flow path 408 and then transferred to the circulation pumps 308a and 308b. The circulation pump 308a and the circulation pump 308b then feed the transferred ink to the first pressure control chamber 304b via the second flow path 410.

As described above, in the circulation path 400, the circulation pumps 308a and 308b are driven, which results in circulation in which ink is supplied to the ejection element substrate 206, ink that has not been ejected is collected from the ejection element substrate 206, and the collected ink is supplied to the ejection element substrate 206 again. This makes it possible to suppress thickening of ink in the ejection element substrate 206.

The configuration of the circulation path 400 is not limited to a form in which ink is circulated between the circulation unit 28 and the ejection unit 26. The effect of suppressing thickening of ink in the ejection element substrate 206 is only required, and for example, the circulation path 400 may be configured such that ink is circulated inside the ejection unit 26. Further, although the circulation path 400 is formed inside the print head 22 mounted on the carriage 20, the present disclosure is not limited to this. For example, a portion of the constituents of the circulation path 400, such as the circulation pump 308, may be provided outside the print head 22.

The first pressure adjustment mechanism 304 and the second pressure adjustment mechanism 306 are provided for the purpose of improving the accuracy of an ink flow rate. Thus, as long as the flow rate of ink circulated by the circulation pump 308 can be appropriately controlled, the first pressure adjustment mechanism 304 and the second pressure adjustment mechanism 306 do not have to be provided.

The circulation pump 308 may be configured to change the volume of the inside of the pump chamber by using a solenoid instead of a piezoelectric element. It is preferable to use, as the circulation pump 308, a pump which causes a relatively small change in the volume of the inside of the pump chamber relative to an applied voltage, such as a piezoelectric element or a solenoid. In other words, it is preferable that the circulation pump 308 be configured to pump liquid by changing the volume of a pumping chamber using a piezoelectric element or a solenoid. However, in a case where a portion of the circulation path 400 is formed outside the print head 22, various known pumps may be used.

### Comparison With Known Technique

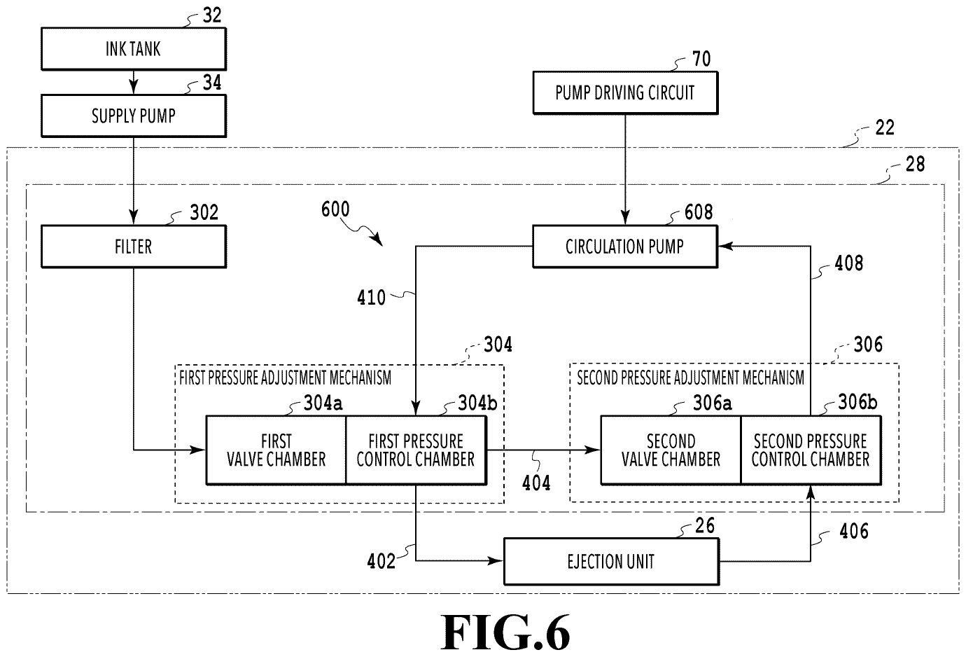

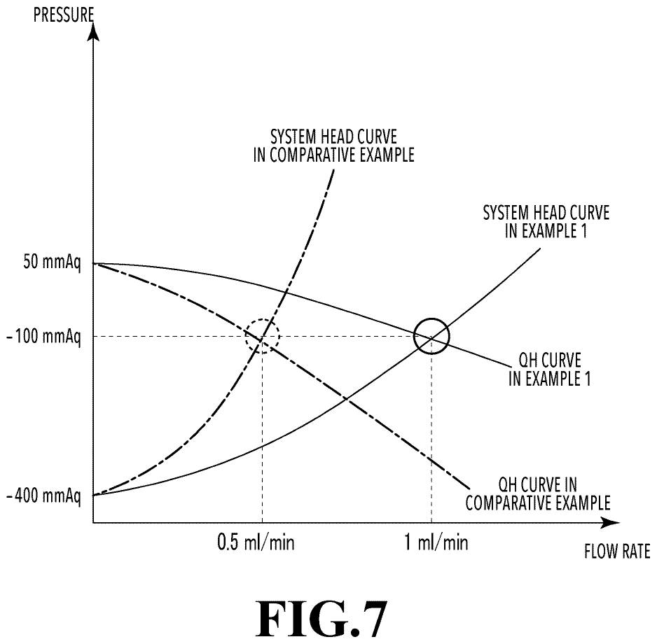

Next, a description will be given of the results of comparison between pump performance in Example 1 which is a technique according to the present embodiment in which the circulation unit 28 is provided with two pumps as circulation pumps and pump performance in a comparative example which is a known technique in which the circulation unit 28 is provided with one pump as a circulation pump. FIG. 6 is a diagram showing a circulation path provided in a print head as a comparative example. FIG. 7 is a diagram showing QH curves and system head curves showing a pump function in Example 1 and a pump function in the comparative example.

A configuration of a circulation path 600 as the comparative example is the same as the configuration of the circulation path 400 as Example 1 except that only one circulation pump 608 for circulating ink is provided (see FIG. 6). Further, the two circulation pumps 308a and 308b in Example 1 and the circulation pump 608 in the comparative example each have the same configuration.

FIG. 7 shows QH curves and system head curves in Example 1 and the comparative example in the case of a pump drive voltage of 40 V. In Example 1 and the comparative example, to properly circulate ink, a required differential pressure between the first pressure control chamber 304b and the second pressure control chamber 306b is 300 mmAq, and a required circulation flow rate is 1 ml/min.

In the comparative example, although it is possible to raise a pressure of-400 mmAq set for the second pressure control chamber 306b by a required differential pressure of 300 mmAq, it is impossible to obtain a required circulation flow rate of 1.0 ml/min (see a dashed-dotted curve in the figure). That is, in the comparative example with the circulation pump 608, in a case where the pressure is raised by a required differential pressure of 300 mmAq, it is impossible to obtain a required circulation flow rate of 1.0 ml/min.

On the other hand, in Example 1, since the circulation pump 308a and the circulation pump 308b are provided in parallel, it is possible to obtain a required circulation flow rate of 1.0 ml/min at the same pump drive voltage (see a solid curve in the figure). That is, in Example 1 with the circulation pumps 308a and 308b connected in parallel, it is possible to obtain a required circulation flow rate of 1.0 ml/min while raising the pressure by a required differential pressure of 300 mmAq, even at the same pump drive voltage as in the comparative example described above.

That is, in Example 1, a required circulation flow rate of 1.0 ml/min can be obtained even at a pump drive voltage at which a required circulation flow rate cannot be obtained in the comparative example. Accordingly, in Example 1, a target differential pressure between the two pressure control chambers and a target circulation flow rate can be obtained at a pump drive voltage lower than in the comparative example, and ink can be appropriately circulated in the circulation path.

### Function and Effect

As described above, in the printing apparatus 10 according to the present embodiment, the plurality of circulation pumps for circulating ink are provided in the circulation path and are connected in parallel. This makes it possible to circulate a target ink in the circulation path while suppressing an increase in drive voltage for the circulation pumps.

### Second Embodiment

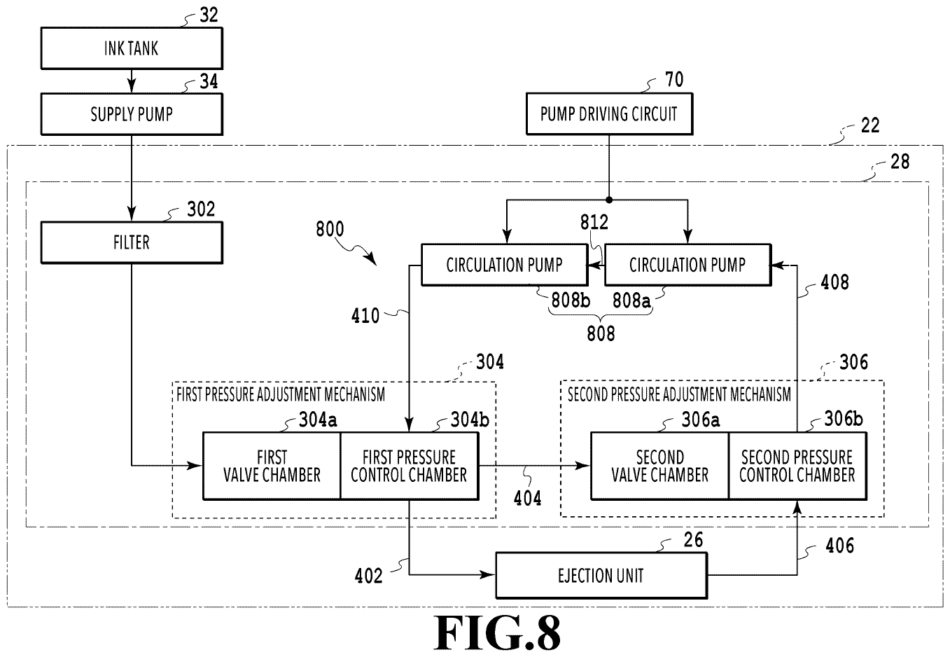

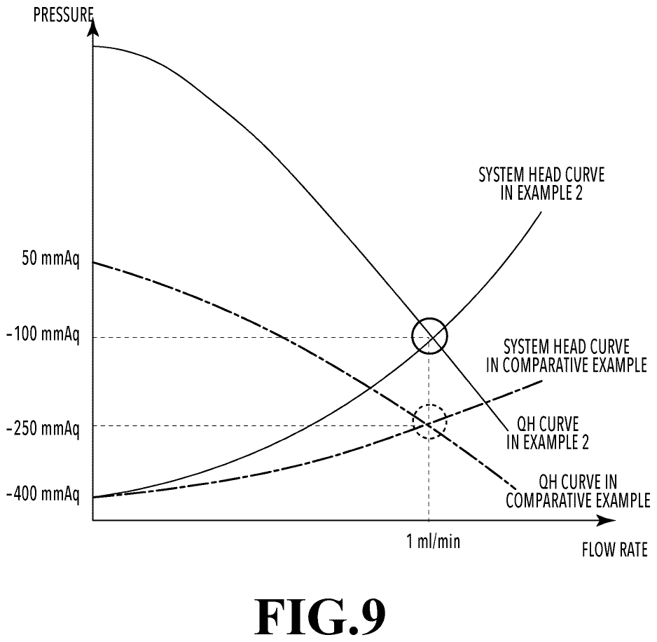

Next, the printing apparatus according to a second embodiment will be described with reference to FIG. 8 and FIG. 9. In the following description, the same reference numeral as that used in the first embodiment will be used for a constituent identical or corresponding to that of the printing apparatus according to the first embodiment, and detailed descriptions thereof will be omitted.

The second embodiment differs from the first embodiment in that a plurality of circulation pumps are connected in series in a circulation path.

### Circulation Path

First, a circulation path 800 in the printing apparatus 10 according to the present embodiment will be described. FIG. 8 is a schematic configuration diagram of the circulation path 800 in the printing apparatus 10 according to the present embodiment. In the circulation path 800 shown in FIG. 8, a circulation pump 808a and a circulation pump 808b are connected in series to the first flow path 408 and the second flow path 410, respectively. The circulation pump 808a is connected to the first flow path 408, and the circulation pump 808b is connected to the second flow path 410. The circulation pump 808a and the circulation pump 808b are connected via a third flow path 812. A specific configuration of the circulation pumps 808a and 808b is the same as that of the circulation pumps 308a and 308b. The circulation path 800 is the same as the circulation path 400 except that the two circulation pumps 808 are directly connected.

Thus, ink flowing into the first valve chamber 304a is transferred from the first pressure control chamber 304b to the second valve chamber 306a via the bypass flow path 404 and is also transferred to the ejection unit 26 via the supply flow path 402. The ink transferred to the ejection unit 26 is transferred to the second pressure control chamber 306b via the collection flow path 406, and the ink transferred to the second valve chamber 306a is transferred to the second pressure control chamber 306b via a valve. The ink transferred to the second pressure control chamber 306b is then transferred to the circulation pump 808a via the first flow path 408, and the circulation pump 808a feeds the transferred ink to the circulation pump 808b via the third flow path 812. The circulation pump 808b feeds the fed ink to the first pressure control chamber 304b via the second flow path 410.

### Comparison With Known Technique

Next, a description will be given of the results of comparison between pump performance in Example 2 in which two pumps are connected in series as circulation pumps and pump performance in the comparative example which is a known technique with one pump as a circulation pump. FIG. 9 is a diagram showing QH curves and system head curves showing a pump function in Example 2 and a pump function in the comparative example.

The comparative example is the same as described above in the first embodiment. Moreover, the two circulation pumps 808a and 808b in Example 2 and the circulation pump 608 in the comparative example each have the same configuration.

FIG. 9 shows QH curves and system head curves in Example 2 and the comparative example in the case of a pump drive voltage of 40 V. In Example 2 and the comparative example, to properly circulate ink, a required differential pressure between the first pressure control chamber 304b and the second pressure control chamber 306b is 300 mmAq, and a required circulation flow rate is 1.0 ml/min.

In the comparative example, although it is possible to obtain the required circulation flow rate, it is impossible to raise a pressure of −400 mmAq set for the second pressure control chamber 306b by a required differential pressure of 300 mmAq (see a dashed-dotted curve in the figure). In other words, in the comparative example with the circulation pump 608, in a case where a required circulation flow rate of 1.0 ml/min is realized, the pressure cannot be raised by a required differential pressure of 300 mmAq.

On the other hand, in Example 2, since the circulation pump 808a and the circulation pump 808b are provided in series, the pressure can be raised by a required differential pressure of 300 mmAq at the same pump drive voltage (see a solid curve in the figure). That is, in Example 2 with the circulation pumps 808a and 808b connected in series, a required circulation flow rate of 1.0 ml/min can be obtained while raising the pressure by a required differential pressure of 300 mmAq even at the same pump drive voltage as in the comparative example.

That is, in Example 2, even at the pump drive voltage at which the required pressure rise cannot be obtained in the comparative example, the pressure can be raised by a required differential pressure of 300 mmAq. Accordingly, in Example 2, a target differential pressure between the two pressure control chambers and a target circulation flow rate can be obtained at a pump drive voltage lower than in the comparative example, and ink can be properly circulated in the circulation path.

### Function and Effect

As described above, in the printing apparatus 10 according to the present embodiment, the plurality of circulation pumps for circulating ink are provided in the circulation path and are connected in series. This makes it possible to achieve the same function and effect as those of the first embodiment.

### Third Embodiment

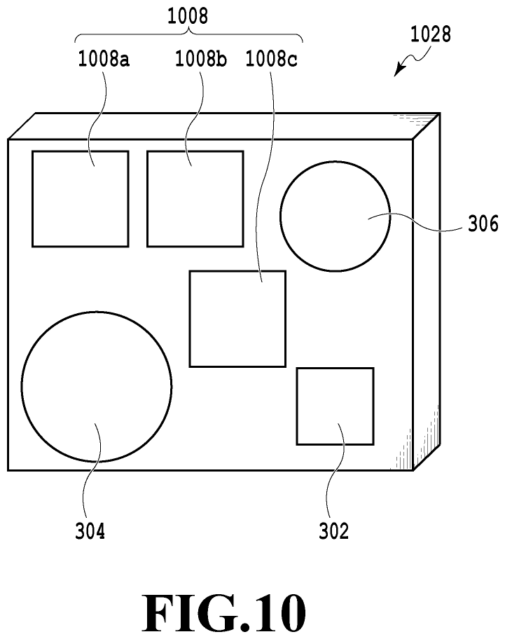

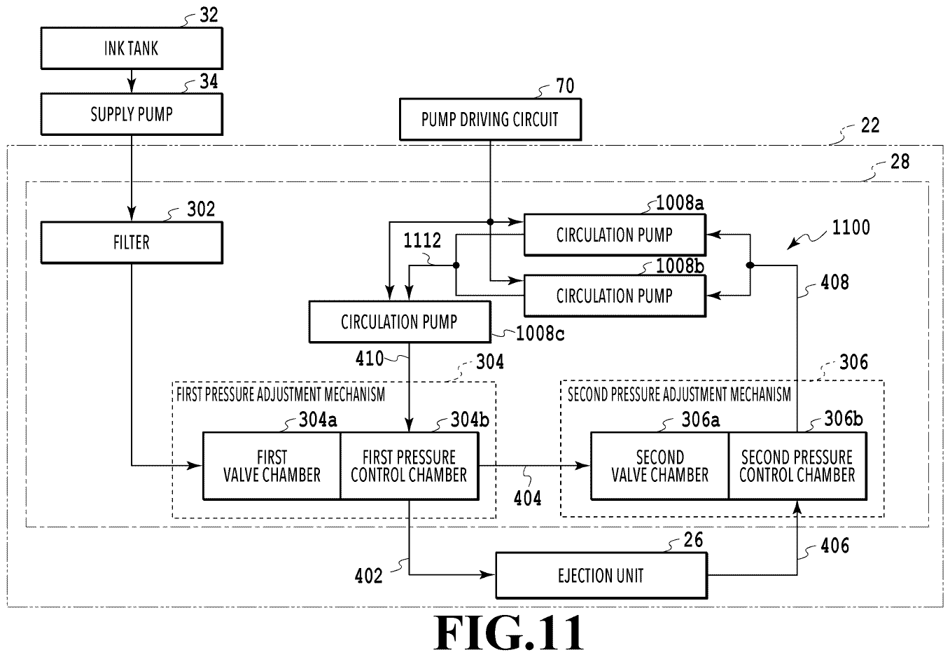

Next, the printing apparatus according to a third embodiment will be described with reference to FIG. 10 and FIG. 11. In the following description, the same reference numeral as that used in the first embodiment will be used for a constituent identical or corresponding to that of the printing apparatus according to the first embodiment, and detailed descriptions thereof will be omitted.

The second embodiment differs from the first embodiment described above in that three circulation pumps are provided in a circulation path.

### Configuration of Circulation Unit

First, a circulation unit 1028 of the printing apparatus 10 according to the present embodiment will be described. FIG. 10 is a schematic configuration diagram of the circulation unit 1028. In the printing apparatus 10 according to the present embodiment, the number of the circulation units 1028 shown in FIG. 10 corresponds to the number of inks used in the printing apparatus 10. The circulation unit 1028 is provided with the filter 302, the first pressure adjustment mechanism 304, the second pressure adjustment mechanism 306, and a plurality of circulation pumps 1008. In the present embodiment, the circulation unit 1028 is provided with the three circulation pumps 1008, that is, a circulation pump 1008a, a circulation pump 1008b, and a circulation pump 1008c. These constituents are connected via respective flow paths as shown in FIG. 11 and constitute a circulation path 1100 (described later) for supplying and collecting ink to and from the ejection unit 26 provided with the ejection element substrate 206 in the print head 22.

### Circulation Path

Next, the circulation path 1100 will be described. FIG. 11 is a schematic configuration diagram of the circulation path 1100 in the printing apparatus 10 according to the present embodiment.

In the circulation path 1100 shown in FIG. 11, the circulation pump 1008a and the circulation pump 1008b are connected in parallel to the first flow path 408 and the second flow path 410, and the circulation pump 1008c is connected in series to the first flow path 408 and the second flow path 410. The circulation pump 1008a and the circulation pump 1008b are connected to the first flow path 408, and the circulation pump 1008c is connected to the second flow path 410. The circulation pump 1008a and the circulation pump 1008b are connected to the circulation pump 1008c via a third flow path 1112. Incidentally, a specific configuration of the circulation pumps 1008a, 1008b, and 1008c is the same as that of the circulation pumps 308a and 308b. The circulation path 1100 is the same as the circulation path 400 except that the circulation path 1100 includes the three circulation pumps 1008.

Thus, ink flowing into the first valve chamber 304a is transferred from the first pressure control chamber 304b to the second valve chamber 306a via the bypass flow path 404 and is also transferred to the ejection unit 26 via the supply flow path 402. The ink transferred to the ejection unit 26 is transferred to the second pressure control chamber 306b via the collection flow path 406, and the ink transferred to the second valve chamber 306a is transferred to the second pressure control chamber 306b via a valve. The ink transferred to the second pressure control chamber 306b is then transferred to the circulation pump 1008a and the circulation pump 1008b via the first flow path 408. The circulation pump 1008a and the circulation pump 1008b feed the transferred ink to the circulation pump 1008c via the third flow path 1112. The circulation pump 1008c feeds the fed ink to the first pressure control chamber 304b via the second flow path 410.

### Function and Effect

As described above, in the printing apparatus according to the present embodiment, the circulation path is provided with the three circulation pumps for circulating ink, two of which are provided in parallel, and the remaining one of which is provided in series with the two circulation pumps. This makes it possible to achieve the same function and effect as those of the first and second embodiments described above.

### Fourth Embodiment

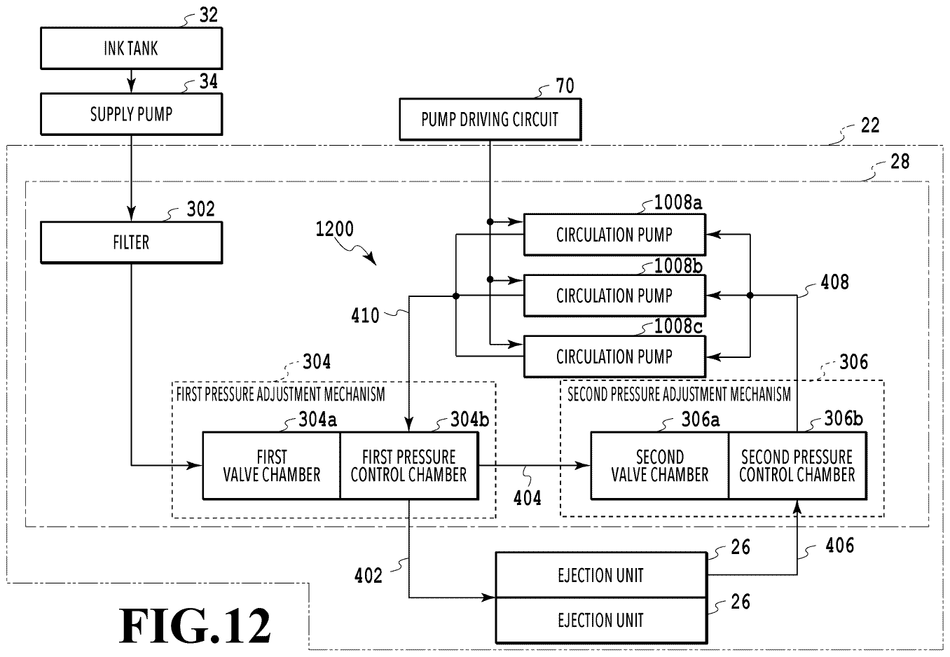

Next, the printing apparatus according to a fourth embodiment will be described with reference to FIG. 12. In the following description, the same reference numeral as that used in the first and third embodiments will be used for a constituent identical or corresponding to that of the printing apparatus according to the first and third embodiments, and detailed descriptions thereof will be omitted.

The fourth embodiment differs from the first embodiment described above in the following respect: a circulation path includes three circulation pumps and a plurality of ejection units. The fourth embodiment also differs from the third embodiment described above in the following respect: a circulation path includes three circulation pumps provided in parallel and a plurality of ejection units.

### Circulation Path

FIG. 12 is a schematic configuration diagram of a circulation path 1200 in the printing apparatus 10 according to the present embodiment. In the circulation path 1200 shown in FIG. 12, the circulation pump 1008a, the circulation pump 1008b, and the circulation pump 1008c are connected in parallel to the first flow path 408 and the second flow path 410. Further, the circulation path 1200 includes the two ejection units 26. Thus, in the printing apparatus 10 according to the present embodiment, ink circulating in the circulation path 1200 can be ejected from the two ejection units 26.

The circulation pump 1008a, the circulation pump 1008b, and the circulation pump 1008c are connected to the first flow path 408 and the second flow path 410. Incidentally, a specific configuration of the circulation pumps 1008a, 1008b, and 1008c is the same as that of the circulation pumps 308a and 308b. The configuration of the circulation path 1200 is the same as that of the circulation path 400 except that the circulation path 1200 includes the three circulation pumps 1008 and the two ejection units 26.

Thus, the ink flowing into the first valve chamber 304a is transferred from the first pressure control chamber 304b to the second valve chamber 306a via the bypass flow path 404 and is also transferred to the ejection unit 26 via the supply flow path 402. The ink transferred to the ejection unit 26 is transferred to the second pressure control chamber 306b via the collection flow path 406, and the ink transferred to the second valve chamber 306a is transferred to the second pressure control chamber 306b via a valve. The ink transferred to the second pressure control chamber 306b is then transferred to the circulation pump 1008a, the circulation pump 1008b, and the circulation pump 1008c via the first flow path 408. The circulation pump 1008a, the circulation pump 1008b, and the circulation pump 1008c feed the transferred ink to the first pressure control chamber 304b via the second flow path 410.

### Function and Effect

As described above, in the printing apparatus according to the present embodiment, in the circulation path, the three circulation pumps for circulating ink are provided and the three circulation pumps are provided in parallel. This makes it possible to achieve the same function and effect as those of the first and second embodiments described above. Further, even in a case where a required circulation flow rate increases by a plurality of ejection units being provided, the required circulation flow rate can be obtained at a relatively low pump drive voltage by providing an additional circulation pump in parallel.

The above-mentioned function and effect obtained by providing an additional circulation pump in parallel are not limited to a case where the plurality of ejection units 26 are provided. Even in a case where the number of ejection energy generating elements (i.e., the number of ejection ports) provided in the ejection element substrate 206 of the ejection unit 26 increases, a required circulation flow rate can be obtained at a relatively low pump drive voltage by providing an additional circulation pump in parallel.

### Fifth Embodiment

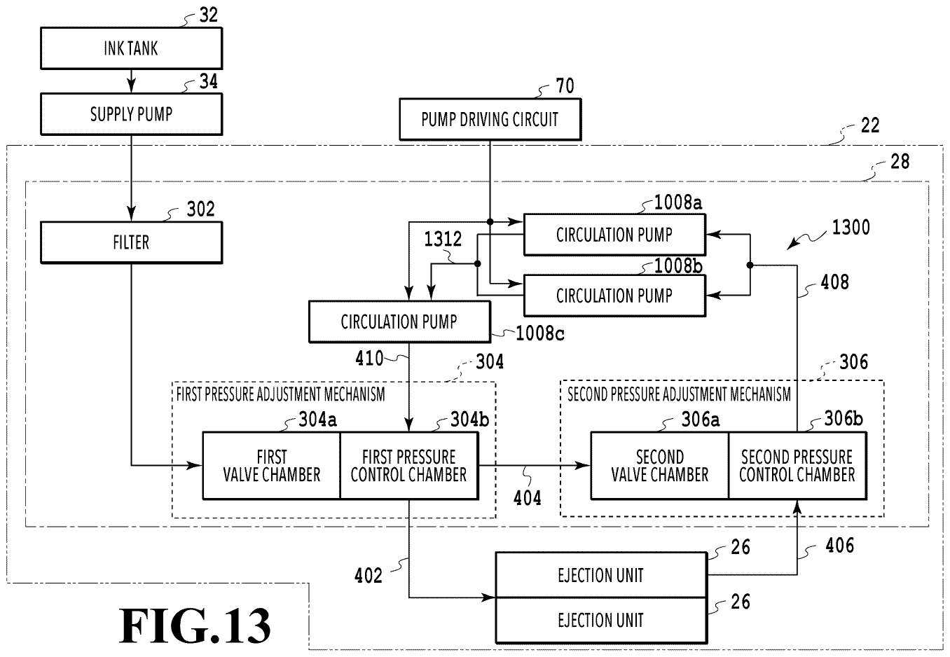

Next, the printing apparatus according to a fifth embodiment will be described with reference to FIG. 13. In the following description, the same reference numeral as that used in the first and third embodiments will be used for a constituent identical or corresponding to that of the printing apparatus according to the first and third embodiments, and detailed descriptions thereof will be omitted.

The fifth embodiment differs from the first embodiment described above in the following respect: a circulation path includes three circulation pumps and a plurality of ejection units. The fifth embodiment also differs from the third embodiment described above in the following respect: a circulation path includes a plurality of ejection units.

### Circulation Path

FIG. 13 is a schematic configuration diagram of a circulation path 1300 in the printing apparatus 10 according to the present embodiment. In the circulation path 1300 shown in FIG. 13, the circulation pump 1008a and the circulation pump 1008b are connected in parallel to the first flow path 408 and the second flow path 410, and the circulation pump 1008c is connected in series to the first flow path 408 and the second flow path 410. Further, the circulation path 1300 includes the two ejection units 26. Thus, in the printing apparatus 10 of the present embodiment, ink circulating in the circulation path 1300 can be ejected from the two ejection units 26.

The circulation pump 1008a and circulation pump 1008b are connected to the first flow path 408, and the circulation pump 1008c is connected to the second flow path 410. The circulation pump 1008a and circulation pump 1008b are connected to the circulation pump 1008c via a third flow path 1312. Incidentally, a specific configuration of the circulation pumps 1008a, 1008b, and 1008c is the same as that of the circulation pumps 308a and 308b. The circulation path 1300 is the same as the circulation path 400 except that the circulation path 1300 includes the three circulation pumps 1008 and the two ejection units 26.

Thus, ink flowing into the first valve chamber 304a is transferred from the first pressure control chamber 304b to the second valve chamber 306a via the bypass flow path 404 and is also transferred to the ejection unit 26 via the supply flow path 402. The ink transferred to the ejection unit 26 is transferred to the second pressure control chamber 306b via the collection flow path 406, and the ink transferred to the second valve chamber 306a is transferred to the second pressure control chamber 306b via a valve. The ink transferred to the second pressure control chamber 306b is then transferred to the circulation pump 1008a and the circulation pump 1008b via the first flow path 408. The circulation pump 1008a and the circulation pump 1008b feed the transferred ink to the circulation pump 1008c via the third flow path 1312. The circulation pump 1008c feeds the fed ink to the first pressure control chamber 304b via the second flow path 410.

### Function and Effect

As described above, in the printing apparatus according to the present embodiment, the circulation path is provided with the three circulation pumps for circulating ink, two of which are provided in parallel, and the remaining one of which is provided in series with the two circulation pumps. This makes it possible to achieve the same function and effect as those of the first and second embodiments described above. Further, even in a case where a required differential pressure between the first pressure control chamber and the second pressure control chamber increases by the plurality of ejection units being provided, the required differential pressure can be obtained at a relatively low pump drive voltage by providing an additional circulation pump in series.

The above-mentioned function and effect obtained by providing an additional circulation pump in series are not limited to a case where the plurality of ejection units 26 are provided. Even in a case where the number of ejection energy generating elements (i.e., the number of ejection ports) provided in the ejection element substrate 206 of the ejection unit 26 increases, the required differential pressure can be obtained at a relatively low pump drive voltage by providing an additional circulation pump in series.

### Sixth Embodiment

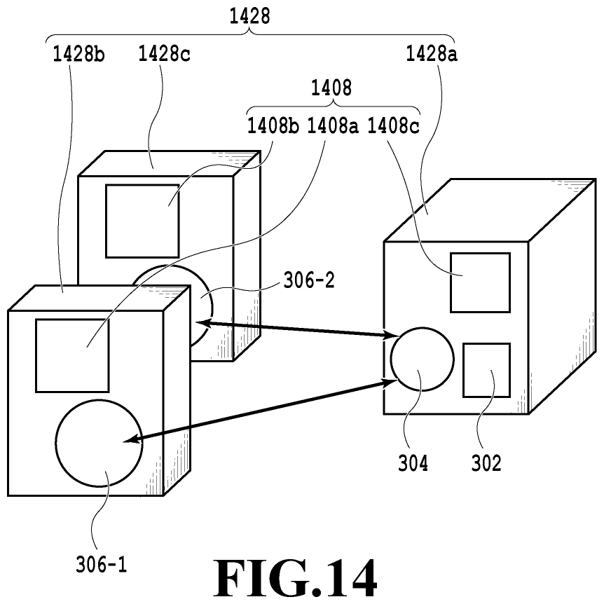

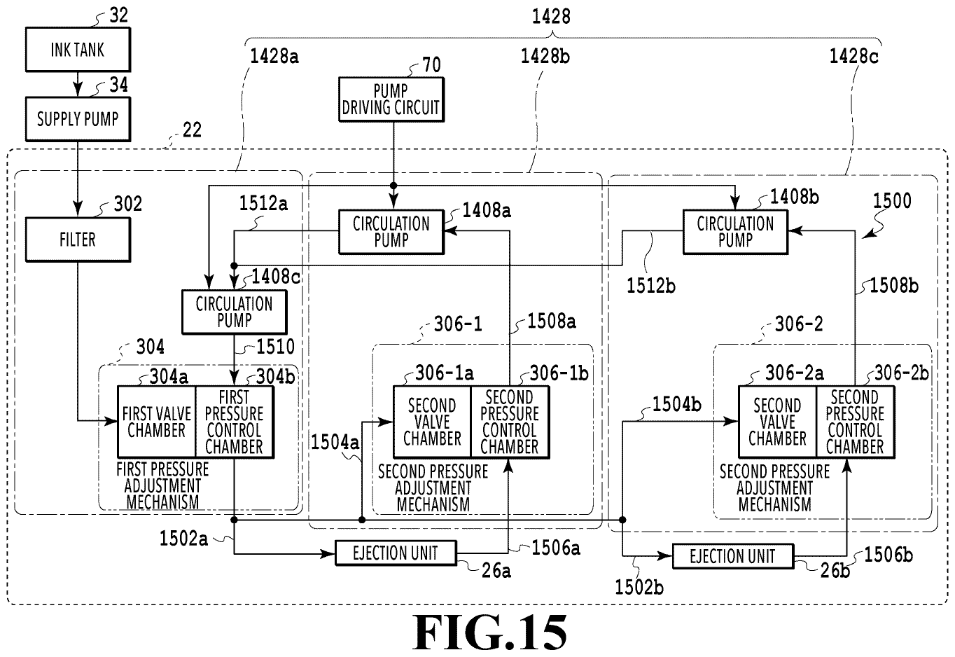

Next, the printing apparatus according to a sixth embodiment will be described with reference to FIG. 14 and FIG. 15. In the following description, the same reference numeral as that used in the first embodiment will be used for a constituent identical or corresponding to that of the printing apparatus according to the first embodiment, and detailed descriptions thereof will be omitted.

The sixth embodiment differs from the first embodiment in the following respect: one circulation unit provided for one ink is formed of three units; and a circulation path includes a plurality of ejection units and three circulation pumps.

### Configuration of Circulation Unit

First, a circulation unit 1428 of the printing apparatus 10 according to the present embodiment will be described. FIG. 14 is a schematic configuration diagram of the circulation unit 1428. The circulation unit 1428 includes a connection circulation unit 1428a and a circulation unit 1428b and circulation unit 1428c connected to the connection circulation unit 1428a. The connection circulation unit 1428a is provided with the filter 302, the first pressure adjustment mechanism 304, and a circulation pump 1408c. The circulation unit 1428b is provided with a second pressure adjustment mechanism 306-1 and a circulation pump 1408a. Further, the circulation unit 1428c is provided with a second pressure adjustment mechanism 306-2 and a circulation pump 1408b. These constituents are connected via respective flow paths as shown in FIG. 15 and constitute a circulation path 1500 (described later) for supplying and collecting ink to and from the ejection unit 26 provided with the ejection element substrate 206 in the print head 22.

### Circulation Path

Next, the circulation path 1500 will be described. FIG. 15 is a schematic configuration diagram of the circulation path 1500 in the printing apparatus 10 according to the present embodiment.

### Configuration of Circulation Path

First, a configuration of the circulation path 1500 will be described. In the circulation path 1500 shown in FIG. 15, the first pressure control chamber 304b is connected to an ejection unit 26a via a supply flow path 1502a and is also connected to a second valve chamber 306-1a of the second pressure adjustment mechanism 306-1 via a bypass flow path 1504a. Further, in the circulation path 1500, the ejection unit 26a is connected to a second pressure control chamber 306-1b of the second pressure adjustment mechanism 306-1 via a collection flow path 1506a. Furthermore, in the circulation path 1500, the second pressure control chamber 306-1b is connected to the circulation pump 1408a via a first flow path 1508a. Moreover, in the circulation path 1500, the circulation pump 1408a is connected via a third flow path 1512a to the circulation pump 1408c provided in the connection circulation unit 1428a, and the circulation pump 1408c is connected via a second flow path 1510 to the first pressure control chamber 304b.

In the circulation path 1500, the first pressure control chamber 304b is connected to an ejection unit 26b via a supply flow path 1502b and is connected to a second valve chamber 306-2a of the second pressure adjustment mechanism 306-2 via a bypass flow path 1504b. Further, in the circulation path 1500, the ejection unit 26b is connected to a second pressure control chamber 306-2b of the second pressure adjustment mechanism 306-2 via a collection flow path 1506b. Furthermore, in the circulation path 1500, the second pressure control chamber 306-2b is connected to the circulation pump 1408b via a fourth flow path 1508b. Moreover, in the circulation path 1500, the circulation pump 1408b is connected to the circulation pump 1408c via a fifth flow path 1512b, and the circulation pump 1408c is connected to the first pressure control chamber 304b via the second flow path 1510.

The circulation pumps 1408a, 1408b, and 1408c have the same configuration which is the same as the configuration of the above-mentioned circulation pump 308. The circulation pumps 1408a, 1408b, and 1408c are driven by a pump drive voltage from the pump driving circuit 70. In the circulation path 1500, the circulation pumps 1408a and 1408b are connected in parallel to the second flow path 1510, and the circulation pump 1408c is connected in series to the second flow path 1510.

### Ink Circulation in Circulation Path

Next, ink circulation in the circulation path 1500 will be described. Ink fed from the ink tank 32 by the supply pump 34 is supplied to the connection circulation unit 1428a via the joint 204 connected to a tube. The ink supplied to the connection circulation unit 1428a passes through the filter 302 to eliminate dust and the like and then flows into the first valve chamber 304a of the first pressure adjustment mechanism 304.

Pressure on the ink flowing into the first valve chamber 304a is adjusted in a case where the ink is transferred to the first pressure control chamber 304b in communication with the first valve chamber 304a via a valve. The ink flowing into the first pressure control chamber 304b is transferred to the supply flow path 1502a, the bypass flow path 1504a, the supply flow path 1502b, and the bypass flow path 1504b by the three circulation pumps 1408 being driven.

The ink transferred from the first pressure control chamber 304b to the supply flow path 1502a is transferred to the ejection unit 26a, and the ink transferred from the first pressure control chamber 304b to the bypass flow path 1504a is transferred to the second valve chamber 306-1a. The ink transferred to the ejection unit 26a is transferred to the ejection element substrate 206 formed in the ejection unit 26a. The ink that has not been ejected from the ejection element substrate 206 is transferred to the second pressure control chamber 306-1b via the collection flow path 1506a. Pressure on the ink transferred to the second valve chamber 306-1a is adjusted in a case where the ink is transferred to the second pressure control chamber 306-1b in communication with the second valve chamber 306-1a via a valve. The ink transferred to the second pressure control chamber 306-1b is transferred to the circulation pump 1408a via the first flow path 1508a. The circulation pump 1408a then feeds the transferred ink to the circulation pump 1408c via the third flow path 1512a, and the ink fed to the circulation pump 1408c is fed by the circulation pump 1408c to the first pressure control chamber 304b via the second flow path 1510.

Further, the ink transferred from the first pressure control chamber 304b to the supply flow path 1502b is transferred to the ejection unit 26b, and the ink transferred from the first pressure control chamber 304b to the bypass flow path 1504b is transferred to the second valve chamber 306-2a. The ink transferred to the ejection unit 26b is transferred to the ejection element substrate 206 formed in the ejection unit 26b. The ink that has not been ejected from the ejection element substrate 206 is transferred to the second pressure control chamber 306-2b via the collection flow path 1506b. Pressure on the ink transferred to the second valve chamber 306-2a is adjusted in a case where the ink is transferred to the second pressure control chamber 306-2b in communication with the second valve chamber 306-2a via a valve. The ink transferred to the second pressure control chamber 306-2b is transferred to the circulation pump 1408b via the fourth flow path 1508b. The circulation pump 1408b then feeds the transferred ink to the circulation pump 1408c via the fifth flow path 1512b, and the ink fed to the circulation pump 1408c is fed by the circulation pump 1408c to the first pressure control chamber 304b via the second flow path 1510.

As described above, the circulation path 1500 includes a path that runs in circles through the connection circulation unit 1428a, the ejection unit 26a, and the circulation unit 1428b, and a path that runs in circles through the connection circulation unit 1428a, the ejection unit 26b, and the circulation unit 1428c. This makes it possible to suppress thickening of ink in the ejection element substrate 206 in each ejection unit.

### Modifications

Although not specifically described in the above explanation, a circulation path does not necessarily have to be formed for all of a plurality of types of inks used in the print head via a circulation unit formed of a plurality of units. A circulation path may also be formed for only a portion of the inks via a circulation unit formed of a plurality of units.

### Function and Effect

The above configuration can produce the same function and effect as in the first and second embodiments described above even in a case where the configuration is scalable such that a circulation unit is formed of a plurality of units for one ink, such as the printing apparatus 10 according to the present embodiment.

### Other Embodiments

The above-described embodiments may be modified as shown in (1) to (5) below.
(1) In the above embodiments, ink is circulated using a plurality of circulation pumps for a circulation path formed in the print head 22, but the present disclosure is not limited to this. Even in a circulation path, a portion of which is formed outside the print head 22, a plurality of circulation pumps may be connected in series or parallel or may be connected by using series and parallel connections in combination.
(2) In the above embodiments, two or three circulation pumps are provided in a circulation path, but the present disclosure is not limited thereto, and four or more circulation pumps may be provided. Further, in the above embodiments, a plurality of circulation pumps are provided between a second pressure control chamber and a first pressure control chamber in a circulation path, but the present disclosure is not limited thereto, and the pumps may be installed in any positions in the circulation path.
(3) In the above embodiments, the printing apparatus 10 is a so-called serial scan type printing apparatus that ejects ink while moving in the width direction of a print medium to perform printing but is not limited to this. For example, the printing apparatus 10 may be a so-called full line type printing apparatus that ejects ink from a plurality of ejection ports arrayed in the width direction of a print medium along a length corresponding to the length of the print medium in the width direction along which printing is possible to perform printing.
(4) Although not specifically described in the above embodiments, a circulation path may be formed of a circulation unit including a plurality of circulation pumps for all four types of inks. Alternatively, a circulation path may be formed of the circulation unit only for a specific type of ink among the four types of inks. In this case, for an ink for which no circulation path is formed of the circulation unit, a circulation path is formed of a circulation unit including only one circulation pump. In other words, a circulation path only has to be formed of a circulation unit including a plurality of circulation pumps for at least one ink among the plurality of types of inks.
(5) The above embodiments and the various modifications shown in (1) to (4) above may be combined as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to circulate liquid while suppressing a pump drive voltage.

This application claims the benefit of Japanese Patent Application No. 2024-192850, filed Nov. 1, 2024, which is hereby incorporated by reference herein in its entirety.

What is claimed is:

1. A liquid ejecting apparatus comprising:
a liquid ejection head comprising an ejection unit capable of ejecting liquid and a circulation path configured to supply liquid to the ejection unit and to collect liquid that has not been ejected from the ejection unit,
wherein the circulation path includes a plurality of pumps configured to pump liquid by displacing a volume of a pump chamber using a piezoelectric element or a solenoid.

2. The liquid ejecting apparatus according to claim 1, wherein the plurality of pumps are driven in response to a same drive signal.

3. The liquid ejecting apparatus according to claim 1, wherein the plurality of pumps are provided in parallel in the circulation path.

4. The liquid ejecting apparatus according to claim 1, wherein the plurality of pumps are provided in series in the circulation path.

5. The liquid ejecting apparatus according to claim 1, wherein a portion of the plurality of pumps are provided in parallel in the circulation path and a remaining portion of the plurality of pumps are provided in series.

6. The liquid ejecting apparatus according to claim 1, wherein the plurality of pumps have a same configuration.

7. The liquid ejecting apparatus according to claim 1, wherein a drive voltage for the plurality of pumps is lower than 42.4 V.

8. A liquid ejection head comprising:
an ejection unit capable of ejecting liquid; and
a circulation unit comprising: a flow path fluidly connected to the ejection unit to supply liquid to the ejection unit; a flow path configured to collect liquid that has not been ejected from the ejection unit; and a plurality of pumps configured to transfer liquid.

9. The liquid ejection head according to claim 8, wherein the pump pumps liquid by displacing a volume of a pump chamber using a piezoelectric element or a solenoid.

10. The liquid ejection head according to claim 8, wherein the plurality of pumps are connected in parallel to the flow path.

11. The liquid ejection head according to claim 8, wherein the plurality of pumps are connected in series to the flow path.

12. The liquid ejection head according to claim 8, wherein a portion of the plurality of pumps are connected in parallel to the flow path and a remaining portion of the plurality of pumps are connected in series to the flow path.

13. The liquid ejection head according to claim 8, wherein the plurality of pumps have a same configuration.

14. The liquid ejection head according to claim 8, wherein the plurality of pumps are driven in response to a same drive signal.

15. The liquid ejection head according to claim 8, wherein a drive voltage for the plurality of pumps is lower than 42.4 V.

16. The liquid ejection head according to claim 8, wherein
the liquid ejection head
is capable of ejecting a plurality of types of liquids and
is provided with the ejection unit and the circulation unit for at least one type of liquid.

17. The liquid ejection head according to claim 8, wherein the circulation unit is provided with a plurality of the ejection units.

18. The liquid ejection head according to claim 8, wherein
the circulation unit comprises:
a first pressure adjustment mechanism configured to adjust pressure on liquid to be supplied to the ejection unit to a relatively high pressure; and
a second pressure adjustment mechanism configured to adjust pressure on liquid collected from the ejection unit to a relatively low pressure.

19. The liquid ejection head according to claim 18, wherein
the circulation unit comprises: a first unit comprising the first pressure adjustment mechanism and the pumps; and a second unit comprising the second pressure adjustment mechanism and the pumps, and
a plurality of the second units are provided for the first unit.

20. A liquid ejecting apparatus comprising:
a conveyance unit configured to convey a medium; and
a liquid ejection head comprising: an ejection unit capable of ejecting liquid; and a circulation unit comprising a flow path fluidly connected to the ejection unit to supply liquid to the ejection unit, a flow path configured to collect liquid that has not been ejected from the ejection unit, and a plurality of pumps configured to transfer liquid,
wherein the liquid ejection head ejects ink onto a medium conveyed by the conveyance unit while moving in a direction intersecting a conveyance direction in which the medium is conveyed by the conveyance unit.
